(19) United States
(12) Patent Application Publication
(10) Pub. No.: US 2026/0349299 A1
(43) Pub. Date: Nov. 5, 2026

(54) DISPLAY MODULE, SPLICED SCREEN, AND DISPLAY APPARATUS

(71) Applicants: BEIJING BOE DISPLAY TECHNOLOGY CO., LTD., Beijing (CN); BOE TECHNOLOGY GROUP CO., LTD., Beijing (CN)

(72) Inventors: Zhanchang BU, Beijing (CN); Changjia FU, Beijing (CN); Haijun SHI, Beijing (CN)

(73) Assignees: BEIJING BOE DISPLAY TECHNOLOGY CO., LTD., Beijing (CN); BOE TECHNOLOGY GROUP CO., LTD., Beijing (CN)

(21) Appl. No.: 19/485,084

(22) PCT Filed: Apr. 19, 2024
(86) PCT No.: PCT/CN2024/088765

§ 371 Date: Nov. 17, 2025

(30) Foreign Application Priority Data
May 18, 2023 (CN) 202310564768.0

(51) Int. Cl. G02F 1/13357; G02F 1/1333; G02F 1/1335

(52) U.S. Cl. CPC G02F 1/133615; G02F 1/133317; G02F 1/13336; G02F 1/133504; G02F 1/133512

(57) ABSTRACT

At least one embodiment of the present disclosure provides a display module, a spliced screen, and a display apparatus, the display module includes a backlight component and a display component, the backlight component includes a middle frame and a back plate, the middle frame includes a first support part configured to support the display component and extending in a first direction, and a second support part carried on the back plate and extending in a second direction, and the first direction and the second direction intersect with each other; the first support part includes a light shielding part, and the second support part is formed of a light transmitting material.

This application claims the priority of China Patent Application No. 202310564768.0 filed on May 18, 2023, and the disclosure of the above-mentioned China Patent Application is hereby incorporated by reference as a part of this application.

### TECHNICAL FIELD

The embodiments of the present disclosure relate to a display module, a spliced screen, and a display apparatus.

### BACKGROUND

The display apparatus formed by a spliced screen is widely used. The display apparatus including the spliced screen is usually formed by splicing a plurality of independent display modules. The display module usually includes a display component and a backlight component. The display component mainly includes a display panel and optical films, and the backlight component mainly includes a middle frame, a light source and a back plate. The middle frame included by the backlight component is arranged at a side of the display component, and the middle frame is provided with a bearing platform capable of bearing the display component, and an accommodating area capable of accommodating the optical films such as a light guide plate, a diffusion plate and a reflective sheet. The bearing platform needs to be connected and fixed with a non-display area of the display component by adhesive, and the middle frame is located at an outer side around the bottom plate of the back plate. The surface of the middle frame has been mirror polished, and the main function of the middle frame is to reflect the light emitted by LED and support the optical films. The back plate included in the backlight component can support the middle frame. The light source includes a plurality of light emitting diodes arranged in an array on the bottom plate of the backplane, and the main function of the light emitting diodes is to provide a backlight source. The optical film is arranged above the light source and is mainly used for processing the light emitted by the light source to improve the uniformity of the display image of the display panel.

### SUMMARY

At least one embodiment of the present disclosure provides a display module, a spliced screen, and a display apparatus, by changing the structural design of the middle frame included in the display module, the middle frame can include a first support part that supports the display component and extends in the first direction, and a second support part that is carried on the back plate and extends in the second direction, and the first support part includes a light shielding part, and the second support part is made of a light transmitting material, on the basis of ensuring the strength and straightness of the middle frame, the shielding of the middle frame to light emitted from the backlight can be reduced to avoid the problem of a dark frame, the problem of edge pixels being blocked, and the problem of edge dark areas of the spliced screen being aggravated due to the width increase of the dark frame.

At least one embodiment of the present disclosure provides a display module, the display module comprises a backlight component and a display component, the backlight component comprises a middle frame and a back plate, the middle frame comprises a first support part configured to support the display component and extending in a first direction, and a second support part carried on the back plate and extending in a second direction, and the first direction and the second direction intersect with each other; the first support part comprises a light shielding part, and the second support part is formed of a light transmitting material.

For example, in the display module provided by at least one embodiment of the present disclosure, the first support part further comprises a light transmitting part wrapping the light shielding part, and the light transmitting part and the second support part are integrally formed.

For example, in the display module provided by at least one embodiment of the present disclosure, in the first direction, an average length of the light shielding part is ¼ to ⅔ of a sum of an average length of a corresponding light transmitting part and the average length of the light shielding part.

For example, in the display module provided by at least one embodiment of the present disclosure, in a plane defined by the first direction and the second direction, a planar shape of the light shielding part at least comprises a quadrangle, the quadrangle comprises a first included angle closest to the display component in the second direction and a second included angle farthest from a corresponding edge of the display component in the first direction, and the first included angle ranges from 60 degrees to 80 degrees, the second included angle ranges from 45 degrees to 60 degrees.

For example, in the display module provided by at least one embodiment of the present disclosure, the first included angle is 75 degrees and the second included angle is 55 degrees, or the first included angle is 64 degrees and the second included angle is 49 degrees.

For example, in the display module provided by at least one embodiment of the present disclosure, a material of the light shielding part comprises aluminum metal, and the light transmitting material comprises polycarbonate doped with diffusion particles, polystyrene doped with diffusion particles or polymethyl methacrylate doped with diffusion particles.

For example, in the display module provided by at least one embodiment of the present disclosure, the display component comprises a diffusion plate, an optical film and a display panel which are sequentially stacked.

For example, in the display module provided by at least one embodiment of the present disclosure, a material of the diffusion plate comprises at least one selected from the group consisting of polystyrene and polycarbonate; the optical film comprises a prism film and a diffusion film which are stacked; the display panel comprises an array substrate and a color filter substrate which are oppositely arranged, and a liquid crystal layer sandwiched between the array substrate and the color filter substrate.

For example, in the display module provided by at least one embodiment of the present disclosure, the back plate and the middle frame are fixed by clamping or locking, and a reflective film and a light source structure are arranged inside the back plate.

For example, in the display module provided by at least one embodiment of the present disclosure, the back plate comprises a bottom plate and a side plate, and a light source structure is arranged on the bottom plate.

For example, in the display module provided by at least one embodiment of the present disclosure, the light source structure comprises a light emitting diode device, and a refractive lens structure or a reflective lens structure is arranged on a light emitting side of the light emitting diode device.

For example, in the display module provided by at least one embodiment of the present disclosure, the light source structure is packaged by a package structure to form a package chip, the package chip is arranged on a base substrate, and a light emitting surface of the package chip is provided with a fluorescent glue.

For example, in the display module provided by at least one embodiment of the present disclosure, a plurality of electrode structures are arranged between the package chip and the base substrate, and the plurality of electrode structures are arranged at intervals.

For example, in the display module provided by at least one embodiment of the present disclosure, a plurality of light source structures are provided, and the plurality of light source structures comprise a first light source structure, a second light source structure and a third light source structure which are adjacent in the first direction and are sequentially away from a first edge of the display component, and a distance between the first light source structure and the first edge of the display component is a first distance D1, a distance between the first light source structure and the second light source structure is a second distance D2, and a distance between the second light source structure and the third light source structure is a third distance D3, the first distance D1 is smaller than the second distance D2, and the second distance D2 is smaller than or equal to the third distance D3.

For example, in the display module provided by at least one embodiment of the present disclosure, in the first direction, from the first edge of the display component to an area of a center of the display component, the closer to the first edge, the smaller a distance between adjacent ones of the plurality of light source structures.

For example, in the display module provided by at least one embodiment of the present disclosure, the first distance D1 is ½ to ⅔ of the second distance D2.

For example, in the display module provided by at least one embodiment of the present disclosure, the second support part is bent and extended in the second direction, and the second support part at least comprises a first extending part, a second extending part, a third extending part and a fourth extending part which are sequentially arranged, and the first extending part is connected with the first support part, and a part of the second extending part connected with the third extending part is depressed to a side close to an edge of the display component, the fourth extending part is connected with the back plate, and the light emitting structure is arranged on the third extending part.

At least one embodiment of the present disclosure further provides a spliced screen, and the spliced screen includes a plurality of display modules according to any one of the embodiments mentioned above, and the spliced screen is formed by splicing the plurality of display modules.

At least one embodiment of the present disclosure further provides a display apparatus, and the display apparatus includes any one of the spliced screen mentioned above.

### BRIEF DESCRIPTION OF DRAWINGS

In order to explain the technical solution of the embodiments of the present disclosure more clearly, the attached drawings of the embodiments will be briefly introduced below. Obviously, the attached drawings in the following description only relate to some embodiments of the present disclosure, and are not limited to the present disclosure.

FIG. 1 is a schematic sectional view of a display module included in a spliced screen;

FIG. 2 is a schematic cross-sectional view of a display module included in another spliced screen;

FIG. 3 is a schematic plan view of a spliced screen provided by at least one embodiment of the present disclosure;

FIG. 4 is a schematic cross-sectional view of a display module included in a spliced screen provided by at least one embodiment of the present disclosure;

FIG. 5 is a schematic cross-sectional view of a middle frame and a part of a display component provided by at least one embodiment of the present disclosure;

FIG. 6 is a schematic cross-sectional view of another middle frame and a part of a display component provided by at least one embodiment of the present disclosure;

FIG. 7 is a schematic cross-sectional view of another middle frame and a part of a display component provided by at least one embodiment of the present disclosure;

FIG. 8 is a schematic cross-sectional view of a light source structure with a refractive lens provided by at least one embodiment of the present disclosure;

FIG. 9 is a schematic cross-sectional view of a light source structure with a refractive lens provided by at least one embodiment of the present disclosure;

FIG. 10 is a light intensity-viewing angle curve of light emitted by a light emitting diode after passing through a reflective lens and a refractive lens, respectively, provided by at least one embodiment of the present disclosure;

FIG. 11 is a schematic cross-sectional view of a package chip formed after packaging a light source structure by a package structure provided by at least one embodiment of the present disclosure;

FIG. 12 is a graph of light intensity versus viewing angle of the package chip shown in FIG. 11;

FIG. 13 is a schematic cross-sectional view of a display module provided by at least one embodiment of the present disclosure;

FIG. 14 is a schematic cross-sectional view of another display module provided by at least one embodiment of the present disclosure;

FIG. 15 is a display image of a spliced screen;

FIG. 16 is a display image of a spliced screen provided by at least one embodiment of the present disclosure; and

FIG. 17 is a block diagram of a display apparatus provided by at least one embodiment of the present disclosure.

### DETAILED DESCRIPTION

In order to make the purposes, technical solutions and advantages of the embodiments of the present disclosure more clear, the technical solutions of the embodiments of the present disclosure will be described clearly and completely with the attached drawings. Obviously, the described embodiments are a part of the embodiments of the present disclosure, not all the embodiment. Based on the described embodiments of the present disclosure, all other embodiments obtained by ordinary skilled in the field without creative labor belong to the protection scope of the present disclosure.

Unless otherwise defined, technical terms or scientific terms used in the present disclosure shall have their ordinary meanings as understood by people with ordinary skills in the field to which the present disclosure belongs. The terms “first”, “second” and the like used in the present disclosure do not indicate any order, quantity or importance, but are only used to distinguish different components. Similar words such as “including” or “containing” refer to that the elements or objects appearing before the word cover the elements or objects listed after the word and their equivalents, without excluding other elements or objects. Similar words such as “connecting” or “connected” are not limited to physical or mechanical connection, but can include electrical connection, whether direct or indirect. “Up”, “Down”, “Left” and “Right” are only used to indicate the relative positional relationship. When the absolute position of the described object changes, the relative positional relationship may also change accordingly.

Because a borderless or narrow-bordered display apparatus can provide the user with more shocking visual experience, it has become a trend in the current display field. Especially in the technical field of spliced screens, the width of the frame of a single display module will directly affect the width of seam of the spliced screen formed after splicing, which will further affect the overall display effect of the spliced screen. Therefore, the spliced screen has higher requirements for the width of the frame, that is, the display modules forming the spliced screen need to have narrower frames, otherwise, the middle frame will block light, resulting in dark frames, and the edge pixels will be blocked, resulting in the aggravation of the edge dark areas. The splicing of a plurality of display modules will double the width of the dark frames and aggravate the edge dark areas, and cause the problem of bad splicing effect.

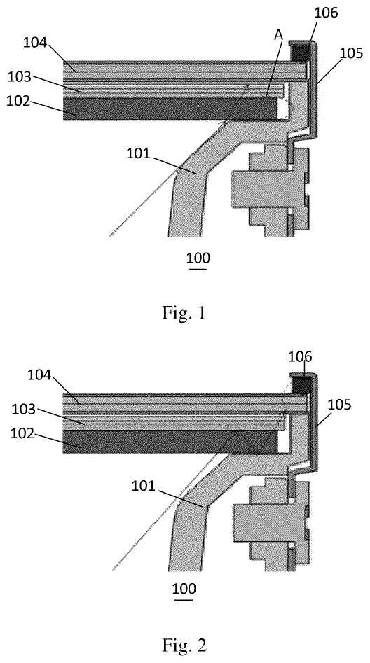

For example, FIG. 1 is a schematic cross-sectional view of a display module included in a spliced screen, and FIG. 2 is a schematic cross-sectional view of a display module included in another spliced screen. As illustrated by FIG. 1 and FIG. 2, the display module 100 includes a middle frame 101, a diffusion plate 102, an optical film 103, a display panel 104, a front frame 105 and an adhesive 106 for bonding the front frame 105 and the display panel 104. For example, as illustrated by FIG. 1, the light emitted from the backlight (not shown in FIG. 1) enters the diffusion plate 102 and the optical film 103 from a surface of the middle frame 101, and then transmits to an edge of the display panel 104. However, no light is emitted from the upper side of the middle frame 101 corresponding to the area A, that is, no light is emitted from the area of the middle frame 101 supporting the diffusion plate 102, thus causing the diffusion plate 102 in this partial area to appear a dark frame and results in a dimming phenomenon in the area. For example, as illustrated by FIG. 2, because the distance between an edge of a support surface for supporting the display panel 104 of the middle frame 101, which is away from the center of the display panel, and the display area in the horizontal direction is less than or equal to 0.1 mm, during the preparing process of the display apparatus, when the display component and the backlight component are offset in the assembling process, the support surface of the middle frame 101, which is used to support the display panel 104, will enter the display area, so that the light emitted from the backlight cannot enter this area of the support surface, which results in the edge pixels being blocked. At present, there is a problem that dark frame exists and edge pixels are blocked around a single display module, when a plurality of display modules are actually spliced to form a spliced screen, the width of the dark frames will be doubled, that is, the widths of the dark frames at the edges of the two display modules will be superimposed, which leads to the phenomenon that the edge dark areas of the spliced screen are aggravated, and then the splicing effect of the spliced screen becomes worse.

The inventor(s) of the present disclosure has noticed that by changing the structural design of the middle frame included in the display module, the middle frame can include a first support part that supports the display component and extends in the first direction, and a second support part that is carried on the back plate and extends in the second direction, and the first support part includes a light shielding part, and the second support part is made of a light transmitting material, on the basis of ensuring the strength and straightness of the middle frame, the shielding of the middle frame to light emitted from the backlight can be reduced to avoid the problem of a dark frame, the problem of edge pixels being blocked, and the problem of edge dark areas of the spliced screen being aggravated due to the width increase of the dark frame.

It should be noted that the strength of the middle frame is large, which can ensure the supporting effect of the middle frame on the display components carried on the middle frame; the straightness of the middle frame is large, which can ensure that there are no protrusions on the surface of the middle frame, so that there is no phenomenon that the protrusions block the light emitted from the backlight and scatter the light.

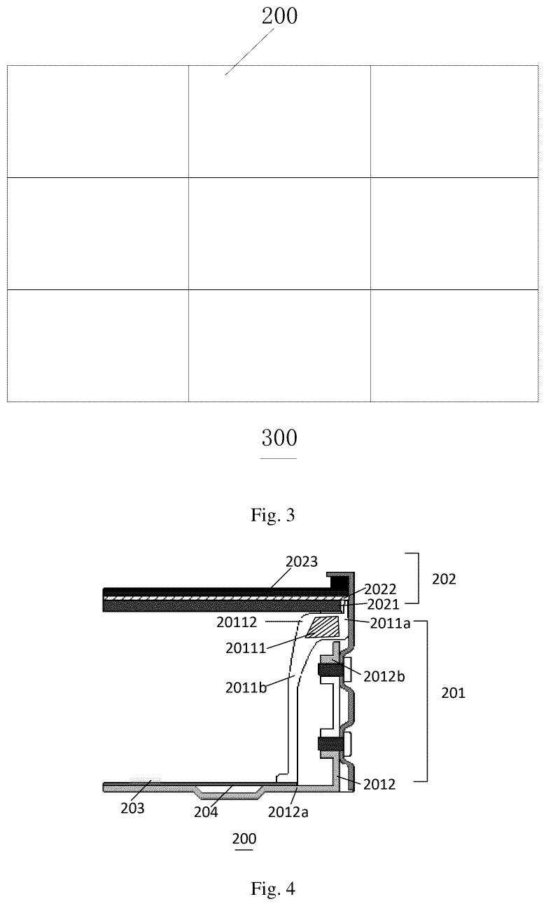

At least one embodiment of the present disclosure provides a spliced screen. For example, FIG. 3 is a schematic diagram of a plane structure of a spliced screen provided by at least one embodiment of the present disclosure. As illustrated by FIG. 3, the spliced screen 300 includes a plurality of display modules 200 connected in sequence. Although the spliced screen 300 is shown in FIG. 3 as a spliced screen formed by splicing nine display modules 200, the embodiments of the present disclosure are not limited thereto, and other numbers of display modules 200 may be included, for example, 2, 4, 6, 12 and so on. A plurality of display modules 200 are spliced with each other, and there is a seam between any two adjacent display modules 200. In some examples, the display module 200 can be a liquid crystal display module, an organic light emitting diode (OLED) display module or an electrophoretic display module. In the following embodiments, the case that the display module 200 is a liquid crystal display module is taken as an example to explain.

For example, FIG. 4 is a schematic cross-sectional view of a display module included in a spliced screen according to at least one embodiment of the present disclosure. As illustrated by FIG. 4, each display module 200 includes a backlight component 201 and a display component 202, the backlight component 201 includes a middle frame 2011 and a back plate 2012, the middle frame 2011 includes a first support part 2011a configured to support the display component 202 and extending in a first direction X, and a second support part 2011b carried on the back plate 2012 and extending in a second direction X, the first direction X and the second direction Y intersect with each other. The first support part 2011a includes a light shielding part 20111, and the second support part 2011b is formed of a light transmitting material.

For example, as illustrated by FIG. 4, the display module 200 further includes a light source structure 203 and a reflective film 204, and the display component 202 includes a diffusion plate 2021, an optical film 2022 and a display panel 2023. The related structures and functions of the light source structure 203, the reflective film 204, the diffusion plate 2021, the optical film 2022 and the display panel 2023 are described in detail below.

For example, light emitting diodes are usually used as the light source structure. Because the light emitted by light emitting diodes has strong directivity, in order to make the light emitted by light emitting diodes mix evenly and form a uniform surface light source, the diffusion plate 2021 arranged above the light emitting diodes needs to keep a sufficient distance from these light emitting diodes, so it is needed to arrange the diffusion plate 2021 at a side of the middle frame 2011 away from a bottom plate of the back plate 2012.

For example, as illustrated by FIG. 4, the first support part 2011a further includes a light transmitting part 20112 wrapping the light shielding part 20111, and the light transmitting part 20112 and the second support part 2011b are integrally formed, that is, the light transmitting part 20112 and the second support part 2011b are formed in the same process step with the same material, so that the types of materials forming the first support part 2011a and the second support part 2011b can be reduced, and the straightness of the middle frame is improved. In addition, the light transmitting part 20112 and the second support part 2011b are integrally formed to form a structure filling a gap of the light shielding part 20111, which can make the whole middle frame 2011 stronger and more stable. Setting the light shielding part 20111 formed of aluminum metal to be wrapped in the light transmitting part 20112 can further increase the strength of the middle frame 2011.

For example, as illustrated by FIG. 4, the light transmitting part 20112 and the second support part 2011b are integrally formed of a light transmitting material by an injection molding process, which can also alleviate the phenomenon of dark frame caused by the shielding of light by the middle frame part located at the edge of the display module, that is, the part supporting the display component 202 and the part including the light shielding part 20111 are formed by an injection molding process, and the injection molding part and the light shielding part 20111 are combined by the injection molding process, and the injection molding part can wrap the light shielding part 20111 during the injection molding process to form an integral structure.

For example, in one example, the light transmitting part 20112 and the second support part 2011b with light transmitting function formed by injection molding process can make the light emitted from the backlight structure first enter the second support part 2011b, and then enter the light transmitting part 20112 of the first support part 2011a included in the display component 202, so that the uniformity of the edge image quality of the display module can be improved.

For example, in one example, the material of the light transmitting part 20112 and the material of the second support part 2011b are both light transmitting materials, and the light transmitting materials may include polycarbonate doped with diffusion particles, polystyrene doped with diffusion particles or polymethylmethacrylate doped with diffusion particles and other transparent materials with a certain strength after curing.

For example, in one example, the back plate 2012 is a supporting structure of the light source structure 203 as a whole, and the back plate 2012 and the middle frame 2011 are fixed by clamping or locking. A reflective film 204 and the light source structure 203 are attached inside the back plate 2012, and the material of the back plate 2012 includes at least one selected from the group consisting of a galvanized steel plate (SECC) and a hot-dip galvanized steel plate (SGCC).

For example, a surface of the middle frame 2011 through which light passes has a scattering effect on light, that is, a scattering surface, and there is a slope surface with a certain inclination angle between the scattering surface of the middle frame 2011 and the optical film 2022. The function of the slope surface is to scatter the light emitted by the light source structure at the edge position, that is, the light emitted by the light source structure at the edge position will be scattered after passing through the slope surface of the middle frame 2011, so that this part of light can easily reach the display area of the display panel to reduce the appearance of dark frames.

For example, as illustrated by FIG. 4, the surface of the second support part 2011b has a scattering reflection function, and light rays will be scattered after being incident on the scattering reflection surface, so that the light rays are scattered to be more evenly incident on the display component. In an example, the surface of the second support part 2011b is attached with a highly scattering reflective film with scattering particles to form the scattering reflective surface, and the surface of the scattering reflective surface is a fog surface.

For example, in another embodiment, a reflective surface is attached to the surface of the second support part 2011b, and a dot pattern layer is attached to the surface of the reflective surface to form the scattering reflective surface.

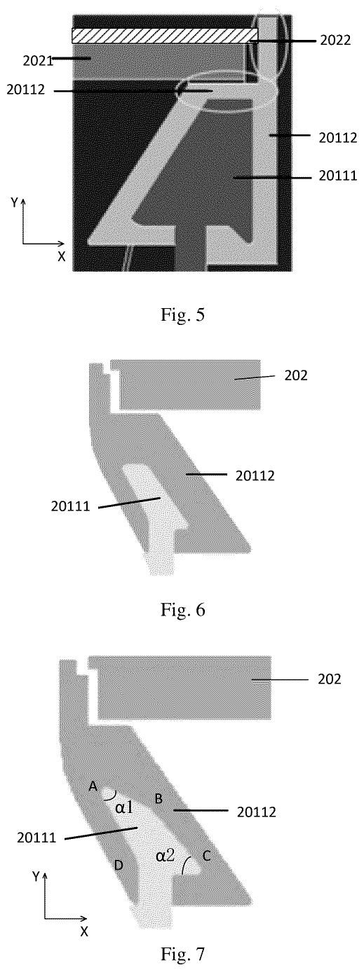

For example, FIG. 5 is a schematic cross-sectional structure diagram of a middle frame and a part of a display component provided by at least one embodiment of the present disclosure. As illustrated by FIG. 5, in an area surrounded by the light transmitting part 20112, the size of the light shielding part 20111 varies in the first direction X, and an average length of the light shielding part 20111 in the first direction X is ¼ of the sum of an average length of a corresponding light transmitting part 20112 in the first direction X and the average length of the light shielding part 20111 in the first direction X. For example, except for the part of the light shielding part 20111 that extends out of the area surrounded by the light transmitting part 20112, the cross-sectional shape of the main part of the light shielding part 20111 is trapezoidal or trapezoid-like, and, in the second direction Y, the closer to the bottom plate of the back plate 2012, the larger the length of the light shielding part 20111 in the first direction X.

For example, in one example, the average length of the light shielding part 20111 in the first direction X is ¼, ⅓, ½ or ⅔ of the sum of the average length of the corresponding light transmitting part 20112 in the first direction X and the average length of the light shielding part 20111 in the first direction X, which is not limited by the embodiment of the present disclosure.

For example, as illustrated by FIG. 5, the part of the light transmitting part 20112 extending out of the light shielding part 20111 in the second direction Y is used to support and contact the optical film 2022, and when the light emitted by the backlight structure irradiates the part of the light transmitting part 20112 extending out of the light shielding part 20111 in the second direction Y, the light can still reach the display panel, so that the problem that the edge pixels are blocked does not occur.

For example, in one example, the material of the optical film 2022 is polyethylene terephthalate, and the optical film 2022 includes a prism film and a diffusion film which are stacked, the prism film is configured to converge light to improve the overall brightness of the display module, and the diffusion film is used to make the light emitted by the light source structure more uniform.

For example, referring to FIG. 4, the display component 202 includes a diffusion plate 2021, an optical film 2022 and a display panel 2023 which are sequentially stacked on the bottom plate of the back plate 2012.

For example, in one example, the material of the diffusion plate 2021 includes at least one selected from the group consisting of polystyrene and polycarbonate. The main function of the diffusion plate 2021 is to make the light emitted by the light source structure more uniform, so as to form a uniform surface light source.

For example, the display panel 2023 includes an array substrate and a color filter substrate which are oppositely arranged, and a liquid crystal layer sandwiched between the array substrate and the color filter substrate, that is, the display panel is a liquid crystal display panel, and the structure of the liquid crystal display panel can refer to the conventional design, for example, switching elements (e.g., thin film transistors) connected with a source line and a gate line which are orthogonal to each other, pixel electrodes connected with the switching transistors, and an alignment film are arranged on the array substrate, color filters of various colors, such as red filters, green filters and blue filters, a black matrix separating the color filters, an alignment film and the like, are arranged on the color filter substrate, and polarizing plates are respectively arranged outside the array substrate and the color filter substrate.

For example, as illustrated by FIG. 4, the back plate 2012 and the middle frame 2011 are fixed by clamping or locking, that is, the back plate 2012 and the middle frame 2011 are detachably connected, so that the back plate 2012 and the middle frame 2011 can have more sufficient space to accommodate the reflective film, the diffusion plate, the optical film and the display panel during assembly, and the above structure can be adjusted more flexibly during installation. A reflective film, a light source structure and so on are arranged inside the back plate 2012.

For example, as illustrated by FIG. 4, in one example, the back plate 2012 includes a bottom plate 2012a and a side plate 2012b, and the reflective film 204 and the light source structure 203 are arranged on the bottom plate 2012a, and the reflective film 204 is arranged between the bottom plate 2012a and the light source structure 203, and can perform a light-equalizing effect on the light emitted from the light source structure 203.

For example, FIG. 6 is a schematic cross-sectional structure diagram of another middle frame and a part of the display component provided by at least one embodiment of the present disclosure. For example, as illustrated by FIG. 6, the width of the edge of the light shielding part 20111 close to the display component 202 can be reduced to reduce the shielding of the light emitted from the light source structure by the light shielding part 20111. For example, the size of the support surface of the upper part of the light shielding part 20111 can be reduced by 60%, and the slope angle remains unchanged. For example, in one example, the size of the support surface of the upper part of the light shielding part 20111 is reduced from 5 mm to 2 mm. For example, on the premise of ensuring the strength of the middle frame 2011, the amount of light incident on the display panel can be increased by reducing the width of the support surface of the upper part of the light shielding part 20111, and then the brightness of the edge of the display module can be improved.

For example, FIG. 7 is a schematic cross-sectional view of another middle frame and a part of a display component provided by at least one embodiment of the present disclosure. As illustrated by FIG. 7, in a plane defined by the first direction X and the second direction Y, a planar shape of the light shielding part 20112 at least includes a quadrangle ABCD including a first included angle α1 closest to the display component 202 in the second direction Y, and a second included angle α2 farthest from the corresponding edge of the display component 202 in the first direction X. The first included angle α1 ranges from 60 degrees to 80 degrees, and the second included angle α2 ranges from 45 degrees to 60 degrees. The first included angle α1 and the second included angle α2 are designed so that the above ranges can be reflected by the inclination angle of the side edge of the middle frame 2011, so that more light can be injected into the edge area of the display module to improve the brightness of the edge of the display module.

For example, in one example, the first included angle α1 is 75 degrees and the second included angle α2 is 55 degrees; in another example, the first included angle α1 is 64 degrees and the second included angle α2 is 49 degrees.

For example, as illustrated by FIG. 7, in one example, the first included angle α1 is designed to be 64 degrees, the second included angle α2 is designed to be 49 degrees, and the width of the support surface of the upper part of the light shielding part 20111 is designed to be 4.2 mm (that is, it is reduced by 0.8 mm compared with the original design), so that more light can be injected into the edge area of the display module through the reflection of the inclination angle of the side of the middle frame 2011, so as to enhance the brightness of the edge of the display module. The brightness of the design in FIG. 7 can be improved by at least 30% compared with the conventional design display module.

For example, in one example, the light source structure 203 can be a light emitting diode, and a refractive lens structure or a reflective lens structure is arranged at a light emitting side of the light emitting diode.

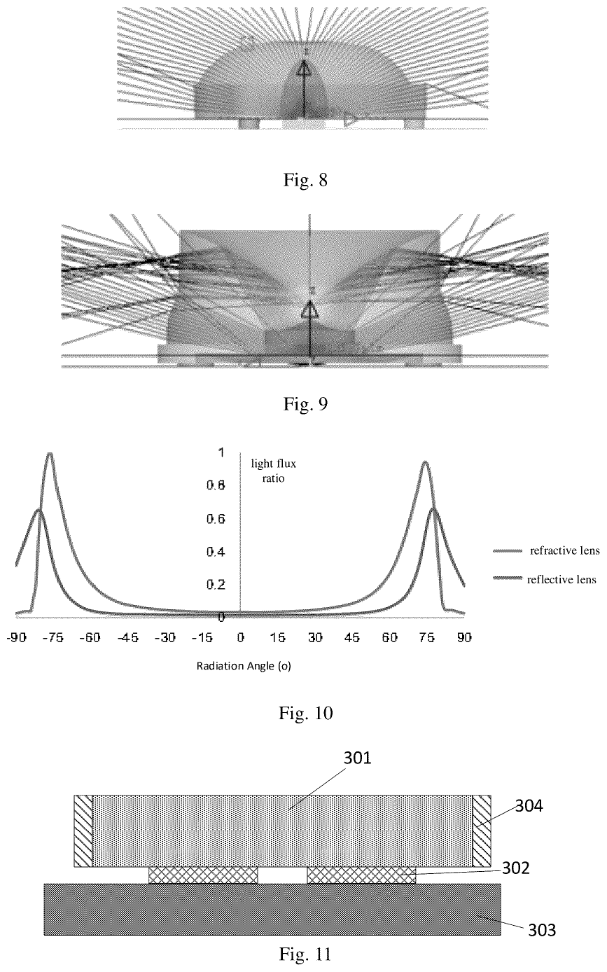

For example, FIG. 8 is a schematic cross-sectional view of a light source structure provided by at least one embodiment of the present disclosure, in which a refractive lens is arranged. The principle of the refractive lens is that the light emitted by a light emitting diode is refracted after passing through the inner wall of the refractive lens, and the angle of the emitting light is deflected, thereby improving the visual angle of the light emitted by the light source structure. The light emitting angle of a common light emitting diode is 120 degrees. For example, as illustrated by FIG. 8, after a refractive lens structure is arranged above the light emitting diode, the light emitting angle of the light source structure can be further improved. For example, the light emitted by the light emitting diode can be improved to about 160 degrees after passing through the refractive lens structure, so that the angle range of the light emitted by the light source structure can be increased, so as to reduce the shielding of the light emitted from the light source structure by the middle frame and avoid the problem of a dark frame, the problem of edge pixels being blocked, and the problem of edge dark areas of the spliced screen being aggravated due to the width increase of the dark frame.

For example, the radius of curvature of the incident surface of the lens structure is larger, so that the light emitted from the light source structure is more divergent, and the light emitting uniformity of the backlight component can be improved, that is, the distance between adjacent light emitting diodes can be set larger, so as to effectively reduce the number of the light emitting diodes and reduce the production cost of the spliced screen.

It should be noted that the light emitting angle is defined as an angle when the light emitting intensity accounts for half of the peak intensity.

For example, FIG. 9 is a schematic cross-sectional view of a light source structure provided by at least one embodiment of the present disclosure with a reflective lens. The principle of the reflective lens is that light with a small angle (e.g., 0-45 degrees) emitted by the light source structure is reflected once after passing through the inner wall of the reflective lens, and this partially reflected light re-enters the reflective film for secondary reflection, and the light is emitted after twice reflection, so that the light emitting angle of the LED becomes larger. The light with a large angle (45~90 degrees) emitted by the light emitting diode is refracted after passing through the inner wall of the reflective lens, and the angle of the emitted light is deflected. As all light rays with small angles are reflected, the brightness directly above the light emitting diode decreases and the light emitting angle of the light emitting diode increases, so the light emitting angle of the light source structure after passing through the reflective lens structure is larger, and the light emitting angle of the light emitting diode after passing through the reflective lens structure can be increased to about 170 degrees.

For example, FIG. 10 shows the light intensity-viewing angle curve of light emitted by a light emitting diode after passing through a reflective lens and a refractive lens respectively, provided by at least one embodiment of the present disclosure. As can be seen from FIG. 10, the light emitting angle of light emitted by a light emitting diode can be increased to about 160 degrees after passing through a refractive lens structure, and the light emitting angle of light emitted by a light emitting diode can be increased to about 170 degrees after passing through a reflective lens structure. After the light emitting diode is matched with reflective lens and refractive lens, the uniformity of the edge image quality of the display module is improved.

For example, FIG. 11 is a schematic cross-sectional view of a package chip formed after the light source structure provided by at least one embodiment of the present disclosure is packaged by a package structure. As illustrated by FIG. 11, a package chip 301 is arranged on a base substrate 303, and the light emitting surface of the package chip 301 is provided with a fluorescent glue 304. For example, as illustrated by FIG. 11, the fluorescent glue 304 is arranged on the left side and the right side of the package chip 301, which is a light emitting diode emitting blue light, and the fluorescent glue 304 is yellow fluorescent glue, so that the blue light emitted by the blue light emitting diode is converted into white light after passing through the yellow fluorescent glue 304.

For example, the material of the fluorescent glue 304 includes a fluorescent powder material or a quantum dot fluorescent layer. For example, the fluorescent material can improve the light emitting efficiency, accurately control the wavelength of light emitted by the package chip 301, and soften the light emitted by the package chip 301. Quantum dot materials have the characteristics of narrow luminescent spectrum, wide color gamut, good stability, long life and low manufacturing cost.

For example, as illustrated by FIG. 11, a plurality of electrode structures 302 are arranged between the package chip 301 and the base substrate 303, and there are gaps between the electrode structures 302, which can help the heat generated by the package chip 301 to dissipate from the gaps, so as to reduce the temperature of the package chip, thus having advantages in high current driving and high temperature resistance.

For example, by coating the lateral surface of the light emitting diode with a fluorescent layer and coating the light emitting surface of the light emitting diode with a light shielding layer, a chip-level packaged light emitting diode (package chip) that emits light only from the lateral surface is formed. That is, the package chip 301 is a CSP (Chip Scale Package) LED that emits light on all lateral surfaces (except that the top surface and the bottom surface do not emit light, all other surfaces emit light). The definition of a chip scale package device is a fully functional package device whose ratio of package size to chip size is not more than 1.2 times. CSP LED is a light emitting diode using CSP packaging process. The structure of the chip-level packaged light emitting diodes is that fluorescent glue is uniformly wrapped around the chip, and then the chip-level packaged devices are mounted on the base substrate.

For example, a fluorescent layer 304 is coated on the lateral surface of the package chip 301, and its thickness is 0~400 μm, which can be adjusted according to the application scenario. For example, there is no gap between the fluorescent layer 304 and the package chip 301, thus ensuring that the emitted light does not have the problem of uneven outgoing light, and further improving the product yield. The light shielding layer is used to shield the light emitted from the light emitting surface of the package chip 301, and the light shielding layer covers the package chip 301 and the fluorescent layer and is consistent with the edge of the fluorescent layer. For example, the thickness of the light shielding layer is 10~500 μm, and there can be no gap, otherwise the problem of light leakage will also occur.

For example, the material of the light shielding layer includes white glue, silica gel or epoxy resin. For example, the white glue has the characteristics of good film forming, high bonding strength, fast curing speed, non-toxicity and low price. Silica gel has the characteristics of high tensile strength, high transparency, non-toxicity and long life. Epoxy resin has the characteristics of good insulation, good thermal conductivity, high temperature resistance, low temperature resistance, good sealing and simple filling process.

For example, the package chip 301 includes at least one selected from the group consisting of a blue light emitting diode chip, a red light emitting diode chip, a green light emitting diode chip and a white light emitting diode chip. Different chips can be selected according to the application scene and the actual requirements of outgoing light. When white light is needed, blue light, red light and green light can be emitted by the blue light emitting diode chip, the red light emitting diode chip and the green light emitting diode chip respectively to form white light, or white light can be directly emitted by the white light emitting diode chip.

For example, because the top of the chip-level package LED does not emit light, there is no problem of uneven light emission between the top side and the lateral side, thus solving the problem that the display products such as a TV, a computer monitor or a mobile phone are prone to light mixing difficulties when the light mixing distance is small, that is, improving the light mixing effect and helping to improve the display effect of the display products.

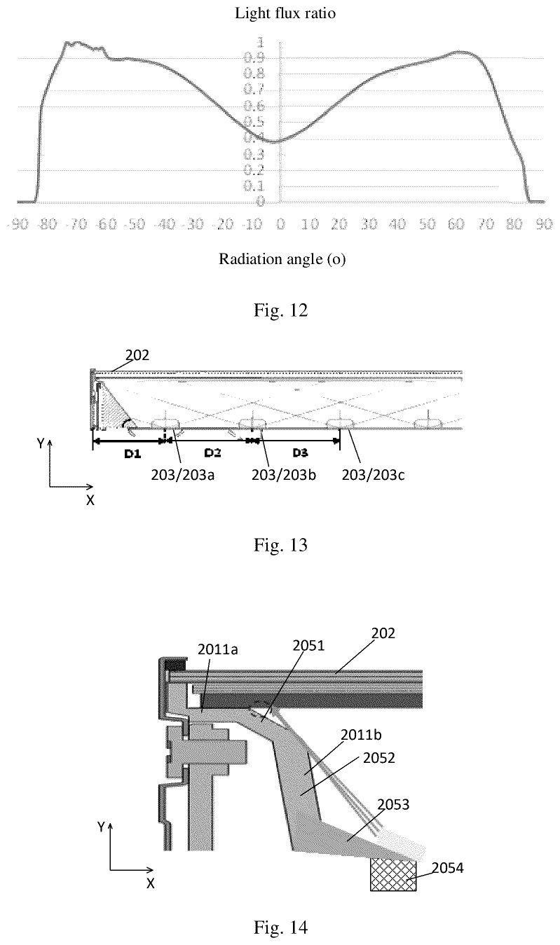

For example, FIG. 12 is a graph of light intensity versus viewing angle of the package chip shown in FIG. 11. As illustrated by FIG. 12, the light emitting angle of the package chip can reach 160 degrees to 170 degrees. Moreover, due to the small size of chip-level packaged LEDs, the arrangement of LEDs can be more dense, which is beneficial to the arrangement design of LEDs at the edge position. Therefore, the light source structure formed by chip-level packaged LEDs can effectively improve the uniformity of emitted light at the edge position.

For example, because the light emitted by light emitting diodes has divergence angle, a dark area will appear between two adjacent light emitting diodes, which will lead to the decrease of the light uniformity of the surface light source provided by the backlight component. Therefore, it is needed to increase the number of light emitting diodes and shorten the distance between two adjacent light emitting diodes to reduce the area of the dark area, that is, a plurality of light source structures can be provided in a display module. In order to improve the uniformity of the emitted light, a plurality of light source structures are usually designed to be arranged in an array. For example, FIG. 13 is a schematic cross-sectional view of a display module provided by at least one embodiment of the present disclosure, as illustrated by FIG. 13, the light source structure 203 includes a first light source structure 203a, a second light source structure 203b and a third light source structure 203c which are adjacent in the first direction X and are sequentially away from the first edge of the display component 202, and the distance between the first light source structure 203a and the first edge of the display component 202 is a first distance D1. The distance between the first light source structure 203a and the second light source structure 203b is a second distance D2, and the distance between the second light source structure 203b and the third light source structure 203c is a third distance D3, the first distance D1 is smaller than the second distance D2, and the second distance D2 is smaller than or equal to the third distance D3. As the closer to the first edge of the display component 202, the greater the risk that the display area of the display component will be blocked. Setting the first distance D1, the second distance D2 and the third distance D3 to the above-mentioned size relationship can reduce the distance between the light source structure 203 closest to the first edge of the display component 202 and the first edge of the display component 202, so that the dark frame area of the edge of the display module can be compensated for brightness, thereby improving the image quality uniformity at the edge of the display module, furthermore, the number of light source structures 203 can be reduced while ensuring the uniform brightness of the display component, so as to lower the cost.

For example, the light source structure in the direct display module, such as light bars, are arranged on the bottom plate of the back plate, and the light of the light source structure of the backlight component is emitted from the bottom plate of the back plate and directly transmitted in the direction perpendicular to the main surface of the display panel. However, due to the limitation of the light emitting angles of the light beads and lenses of the light source structure, the light beads arranged on the bottom plate of the back plate need to be evenly distributed on the bottom plate so that the light can be emitted uniformly. For example, if the number of the light bars on the light source structure is large, it is not conducive to the processing and assembly of backlight components, and it is not conducive to saving materials and making the processing cost higher. Therefore, it is needed to consider adjusting the distance between adjacent light source structures to reduce the number of the light source structures and ensure the uniformity of brightness of the display components.

It should be noted that the types and selections of the first light source structure 203a, the second light source structure 203b and the third light source structure 203c can be found in the relevant description of the light source structure 203, and a plurality of light source structures 203 are arranged in an array on the bottom plate of the back plate, and only a plurality of light source structures 203 arranged adjacently in the first direction X are shown in FIG. 13.

It should also be noted that the first edge of the display component refers to the edge of the display component that is closest to the described light source structure. For example, when describing the leftmost light source structure 203 in FIG. 13, that is, the first light source structure 203a, the first edge of the display component refers to the leftmost edge of the display component, and when describing the rightmost light source structure 203 not shown in FIG. 13, the first edge of the display component refers to the rightmost edge of the display component.

For example, when the first distance D1, the second distance D2 and the third distance D3 are all equal, and the distance from the first edge of the display component 202 is less than or equal to 70 mm, the illumination of the light source structure 203 will be relatively low, that is, a dark frame phenomenon will appear at the edge of the display component 202. When the first distance D1 is designed to be smaller than the second distance D2 and the second distance D2 is designed to be smaller than or equal to the third distance D3, the brightness of the dark frame area of the first edge of the display component can be compensated, so that the uniformity of the image quality at the edge of the display module can be improved.

For example, as illustrated by FIG. 13, in the first direction X, from the first edge of the display component 202 to the area of the center of the display component 202, the closer to the first edge, the smaller the distance between adjacent light source structures 203, that is, the arrangement density of light source structures located at the edge area of the bottom plate of the back plate 2012 is greater than that located in the middle area of the bottom plate of the back plate 2012, which allows for a reduction in the number of light source structures to cut costs, while maintaining brightness uniformity of the display component.

For example, in one example, the first distance D1 is ½ to ⅔ of the second distance D2. Setting the ratio of the first distance D1 to the second distance D2 to the above-mentioned proportional range can reduce the distance between the light source structure closest to the first edge and the first edge, so that the brightness of the edge dark frame area of the display module can be compensated, thereby further improving the uniformity of the edge image quality of the display module.

For example, in one example, the first distance D1 ranges from 35 mm to 45 mm, the second distance D2 ranges from 55 mm to 70 mm, and the third distance D3 ranges from 75 mm to 90 mm.

For example, in one example, the first distance D1 is 39 mm, the second distance D2 is 62 mm, and the third distance D3 is 76 mm.

It should be noted that in the spliced screen provided by the embodiment of the present disclosure, element A and element B are adjacent, or adjacent elements A and B refer to that there are no other elements A and B between the elements A and B, but there may be other elements except elements A and B. Element A and element B can be the same element or different elements.

For example, because the spliced screen includes a plurality of display modules that can meet the requirements of ultra-narrow frame design, the reflective surface of the middle frame cannot be perpendicular to the optical film, but a space needs to be reserved between the bottom of the middle frame and the back plate, and the reflective surface of the middle frame is designed as a slope surface with a certain inclination angle with the optical film, and the main function of the slope surface is to reflect the light emitted by the light source structure at the edge position of the back plate. The inclined angle of the inclined surface of the middle frame is usually designed to be 50 degrees to 75 degrees, and the light source structures in the light source structures are arranged at equal intervals. Because the light source structures reflect light on the inclined surface at the edge position of the display component, there is a bright edge at the edge position of the display screen of the display component. In addition, the uniformity of display brightness is high in the middle of the display screen, but the brightness is low at the edge of the display screen, and there will be a transition zone from high brightness to low brightness at the edge of the display screen, and there will be obvious black frames at the edge of the display screen, which will affect the display screen of the final product. The inventor(s) of the present disclosure also noticed that the second support part of the middle frame can be designed to bend and extend, which can improve the brightness at the edge of the display screen and eliminate the transition zone from high brightness to low brightness at the edge of the display screen and the obvious dark frame.

For example, FIG. 14 is a schematic cross-sectional structure diagram of another display module provided by at least one embodiment of the present disclosure. As illustrated by FIG. 14, the second support part 2011b is bent and extended in the second direction Y, and the second support part 2011b at least includes a first extending part 2051, a second extending part 2052, a third extending part 2053 and a fourth extending part 2054 which are sequentially arranged, the first extending part 2051 is connected with the first support part 2011a, and a part of the second extending part 2052 connected with the third extending part 2053 is depressed to a side close to the edge of the display component 202, the fourth extending part 2054 is connected with the back plate (not shown in FIG. 14), and the third extending part 2053 is provided with a light source structure 203, and the light emitted from the light source structure 203 is not reflected by other structures in the middle frame 2011, so that the area of the blocked part of the display component 203 is reduced, so as to further guarantee the uniformity of the display brightness of the display component.

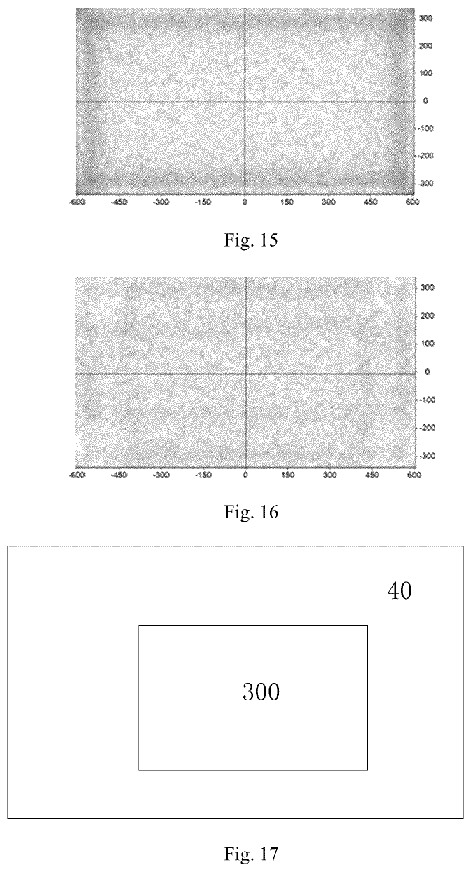

For example, FIG. 15 is a display image of a spliced screen, and FIG. 16 is a display image of a spliced screen provided by at least one embodiment of the present disclosure. As illustrated by FIG. 15, it can be clearly seen that there are dark frames around the display image on the spliced screen, the uniformity of the edge image quality of the display image of the spliced screen is poor, and there are obvious dark frame edges at the frame of the display image. As illustrated by FIG. 16, there is no obvious dark frame around the display image of the spliced screen, and the edge image quality of the display image of the spliced screen is uniform, and the distribution density of scattered points everywhere in the display image is the same, that is, the phenomenon of poor edge image quality of the display image of the spliced screen is alleviated through the design of some embodiments of the present disclosure.

At least one embodiment of the present disclosure further provides a display apparatus. For example, FIG. 17 is a block diagram of a display apparatus provided by at least one embodiment of the present disclosure. As illustrated by FIG. 17, the display apparatus 40 includes a spliced screen 300 provided by any one of the above embodiments, which are formed by splicing a plurality of display modules 200. The display apparatus in the embodiment of the present disclosure can be a display, an OLED panel, an OLED TV, an electronic paper, a mobile phone, a tablet computer, a notebook computer, a digital photo frame, a navigator and other products or components with display functions.

The display module, the spliced screen and the display apparatus provided by at least one embodiment of the present disclosure have at least one of the following beneficial technical effects:
(1) In the display module provided by at least one embodiment of the present disclosure, by changing the structural design of the middle frame, the middle frame includes a first support part that supports the display component and extends in the first direction, and a second support part that is carried on the back plate and extends in the second direction, and the first support part includes a light shielding part, and the second support part is made of a light transmitting material, so that on the basis of ensuring the strength and straightness of the middle frame, the shielding of the middle frame to light emitted from the backlight can be reduced to avoid the problem of a dark frame, the problem of edge pixels being blocked, and the problem of edge dark areas of the spliced screen being aggravated due to the width increase of the dark frame.
(2) In the display module provided by at least one embodiment of the present disclosure, the light transmitting part and the second support part are integrally formed to form a structure filling a gap of the light shielding part, which can make the whole of the middle frame stronger and more stable. The strength of the middle frame can be further increased by arranging the light shielding part made of aluminum metal to be wrapped in the light transmitting part.

The following points need to be explained:
(1) The drawings of the embodiment of the present disclosure only relate to the structure related to the embodiment of the present disclosure, and other structures can refer to the general design.
(2) For the sake of clarity, in the drawings used to describe the embodiments of the present disclosure, the thicknesses of layers or regions are enlarged or reduced, that is, these drawings are not drawn to actual scale.
(3) In the case of no conflict, the embodiments of the present disclosure and the features in the embodiments can be combined with each other to obtain a new embodiment.

The above is only the specific implementation of the present disclosure, but the protection scope of the present disclosure is not limited thereto, and the protection scope of the present disclosure should be subject to the protection scope of the claims.

1. A display module, comprising a backlight component and a display component,
wherein the backlight component comprises a middle frame and a back plate, the middle frame comprises a first support part configured to support the display component and extending in a first direction, and a second support part carried on the back plate and extending in a second direction, and the first direction and the second direction intersect with each other;
the first support part comprises a light shielding part, and the second support part is formed of a light transmitting material.

2. The display module according to claim 1, wherein the first support part further comprises a light transmitting part wrapping the light shielding part, and the light transmitting part and the second support part are integrally formed.

3. The display module according to claim 2, wherein, in the first direction, an average length of the light shielding part is ¼ to ⅔ of a sum of an average length of a corresponding light transmitting part and the average length of the light shielding part.

4. The display module according to claim 3, wherein, in a plane defined by the first direction and the second direction, a planar shape of the light shielding part at least comprises a quadrangle, the quadrangle comprises a first included angle closest to the display component in the second direction and a second included angle farthest from a corresponding edge of the display component in the first direction, and the first included angle ranges from 60 degrees to 80 degrees, the second included angle ranges from 45 degrees to 60 degrees.

5. The display module according to claim 4, wherein the first included angle is 75 degrees and the second included angle is 55 degrees, or the first included angle is 64 degrees and the second included angle is 49 degrees.

6. The display module according to claim 2, wherein a material of the light shielding part comprises aluminum metal, and the light transmitting material comprises polycarbonate doped with diffusion particles, polystyrene doped with diffusion particles or polymethyl methacrylate doped with diffusion particles.

7. The display module according to claim 6, wherein the display component comprises a diffusion plate, an optical film and a display panel which are sequentially stacked.

8. The display module according to claim 7, wherein a material of the diffusion plate comprises at least one selected from the group consisting of polystyrene and polycarbonate;
the optical film comprises a prism film and a diffusion film which are stacked; the display panel comprises an array substrate and a color filter substrate which are oppositely arranged, and a liquid crystal layer sandwiched between the array substrate and the color filter substrate.

9. The display module according to claim 1, wherein the back plate and the middle frame are fixed by clamping or locking, and a reflective film and a light source structure are arranged inside the back plate.

10. The display module according to claim 1, wherein the back plate comprises a bottom plate and a side plate, and a light source structure is arranged on the bottom plate.

11. The display module according to claim 10, wherein the light source structure comprises a light emitting diode device, and a refractive lens structure or a reflective lens structure is arranged on a light emitting side of the light emitting diode device.

12. The display module according to claim 10, wherein the light source structure is packaged by a package structure to form a package chip, the package chip is arranged on a base substrate, and a light emitting surface of the package chip is provided with a fluorescent glue.

13. The display module according to claim 12, wherein a plurality of electrode structures are arranged between the package chip and the base substrate, and the plurality of electrode structures are arranged at intervals.

14. The display module according to claim 10, wherein a plurality of light source structures are provided, and the plurality of light source structures comprise a first light source structure, a second light source structure and a third light source structure which are adjacent in the first direction and are sequentially away from a first edge of the display component, and a distance between the first light source structure and the first edge of the display component is a first distance D1, a distance between the first light source structure and the second light source structure is a second distance D2, and a distance between the second light source structure and the third light source structure is a third distance D3, the first distance D1 is smaller than the second distance D2, and the second distance D2 is smaller than or equal to the third distance D3.

15. The display module according to claim 14, wherein, in the first direction, from the first edge of the display component to an area of a center of the display component, the closer to the first edge, the smaller a distance between adjacent ones of the plurality of light source structures.

16. The display module according to claim 14, wherein the first distance D1 is ½ to ⅔ of the second distance D2.

17. The display module according to claim 15, wherein the second support part is bent and extended in the second direction, and the second support part at least comprises a first extending part, a second extending part, a third extending part and a fourth extending part which are sequentially arranged, and the first extending part is connected with the first support part, and a part of the second extending part connected with the third extending part is depressed to a side close to an edge of the display component, the fourth extending part is connected with the back plate, and the light emitting structure is arranged on the third extending part.

18. A spliced screen, comprising a plurality of display modules according to claim 1, wherein the spliced screen is formed by splicing the plurality of display modules.

19. A display apparatus, comprising the spliced screen according to claim 18.

20. The display module according to claim 3, wherein a material of the light shielding part comprises aluminum metal, and the light transmitting material comprises polycarbonate doped with diffusion particles, polystyrene doped with diffusion particles or polymethyl methacrylate doped with diffusion particles.
